(19) United States
(12) Patent Application Publication
(10) Pub. No.: US 2003/0167218 A1
(43) Pub. Date: Sep. 4, 2003

(54) Modular financial service instrument

(76) Inventors: Michelle D. Field, Oakville (CA); Christopher Barrett, Toronto (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 10/214,701

(22) Filed: Aug. 9, 2002

(51) Int. Cl. G06F 17/60

(52) U.S. Cl. 705/35

(57) ABSTRACT

A modular financial service instrument is disclosed herein. The modular financial service instrument allows both the customer and the issuing financial institution to modify the set of features associated with the instrument without requiring the issuing of a new instrument. The modular nature of the instrument allows for a rationalised operational structure that eliminates the necessity for storing each combination of features as a separate product. The modular nature of the instrument allows a customer to select features to create a customisable financial service instrument that suites the customer needs.

### FIELD OF THE INVENTION

The present invention relates generally to management of financial service instruments. More particularly, the present invention relates to the electronic management of credit and charge cards in a financial institution.

### BACKGROUND OF THE INVENTION

In the financial services industry, financial instruments, such as deposit accounts, lines of credit, mortgages and credit cards are targeted to attract client bases through a mix of services and rewards attached to the instrument. For example, many financial institutions provide a mix of credit and charge cards with varying fees and interest rates and also offer customer rewards ranging from rebating a percentage of the annual spending, to grocery vouchers, to frequent flier or other loyalty reward program points. Many institutions have extended this model to deposit and debt instruments such as mortgages, by offering reward points either based on monthly outstanding balances or on a transactional basis.

Within each family of credit cards, there are a number of affinity programs, reward programs, and other optional services that can be subscribed to. Each combination of these features is presently stored as a separate product in a product database. This results in different product profiles for a credit card offering a low interest rate and a credit card without fees, but with a higher interest rate. If a financial institution offers a choice of reward programs, each card having a different reward program is profiled as a different product, as are the high and low interest rate versions of the card. When insurance programs, such as Out of Country Medical Insurance (OOCM), are added to cards the number of products is further increased. As one of skill in the art will recognise, each additional feature or program offered can create tens or hundreds of different products due to the combination of different affinity, payment, interest and reward packages available on a simple credit card. As these rewards and services are extended to other financial service instruments, the present method of organising financial service instruments becomes very unwieldy. The number of differing products offered, even in a single area such as credit card and charge cards, can overwhelm a simple product tracking system.

To control the number of credit card products, many financial institutions only make available certain features, such as OOCM and travel insurance, to customers who qualify for premium cards, such as gold and platinum cards. These premium cards typically bundle high credit limits with an annual fee and a variety of bonus features that are designed to appeal to an assumed typical customer. As a result, customers who want to subscribe to a service, but cannot meet the credit requirements of a premium card, are not eligible to subscribe. This restricts these individuals from buying a service that can be potentially profitable for the issuing financial institution.

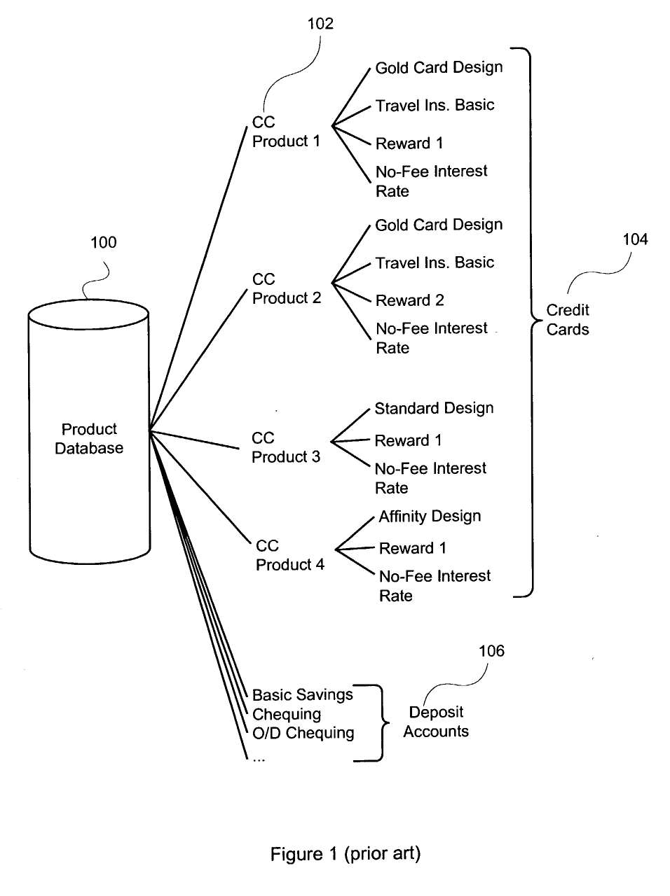

The desire to control the number of products stems from the task of managing the operational systems used to support the financial instruments. Each product, which is defined by the combination of fees, rates, rewards, card design and other features, is stored as a product profile in a product database. As illustrated in FIG. 1, product database 100 stores a product profile 102 for each instrument offered 104, 106. These product profiles can be organised to sort on the basis of the classification of the underlying instrument. As one of skill in the art will readily appreciate, the combination of features, rates, fees and other features such as OOCM, result in a large number of stored product profiles. Typically, if a special instrument is created, such as a discounted interest rate on a mortgage for all members of an affiliate organisation, a new product profile is created. Occasionally, when old products are terminated, a number of orphan accounts are grandfathered in to maintain customer loyalty. Thus the number of product profiles is at best a non-decreasing quantity, and in reality is actually increasing.

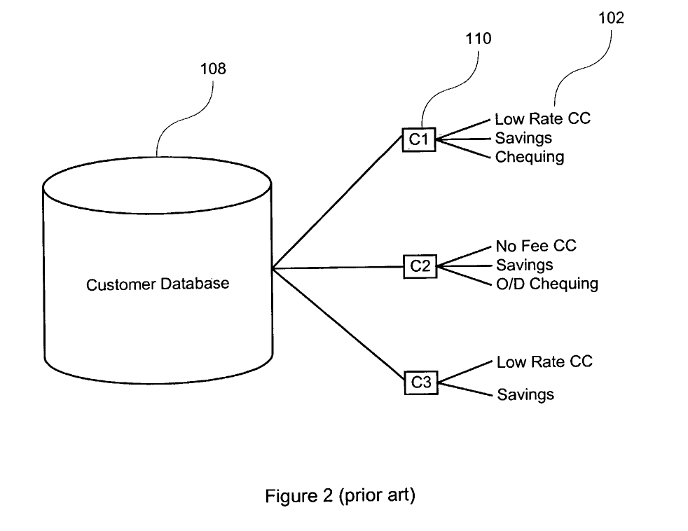

Each client of the financial institution also has a profile stored in a customer database 108, as shown in FIG. 2. A customer 110 has a unique profile containing a set of product profiles 102, which have predefined properties as well as dynamic properties such as outstanding balance information. Each product profile 102 in a customer's profile has a uniquely assigned access identification numbers (Access IDs). The indexing structure allows a customer profile to be accessed by performing searching using one of the Access IDs assigned to the product profiles 102 associated with the customer profile.

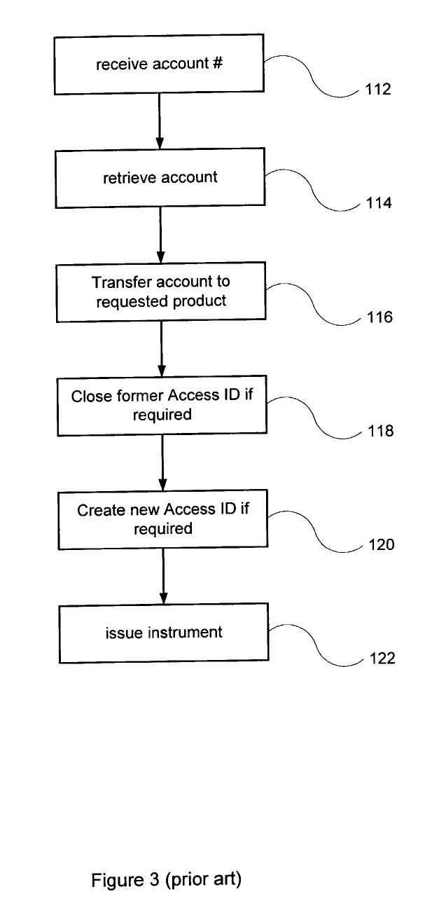

Because each variety of instrument has a distinct product profile, changing features associated with various instruments is not a simple process. Typically, customers are attached to an account number and do not want to change it. As a result, a method similar to that illustrated in FIG. 3 is used to modify the features of a financial instrument. The account number is received 112 and is used to retrieve the account information 114. The account information retrieved in 114 contains information used by the financial institution to identify the history of the customer. The retrieved account information is then transferred to the requested product in 116. If the product change is sufficiently different, such as the change between a standard and a gold credit card, the Access ID that was associated with the account is closed in 118, and a new Access ID is created in 120. The new financial service instrument is then issued to the customer in 122. This process may require that the customer be issued a new card associated with the product and may additionally require a new account number to be provided to the customer. The overall process is cumbersome when the customer simply wants to ard programs.

It should be readily appreciated that benefits exist in unbundling features from premium instruments to make available individual features to any customer, as it would allow customers a greater choice in the selection of features in relation to their financial instruments. Additionally, a rationalisation in the manner in which financial instruments are created and stored would provide operational benefits to the financial institution.

It is, therefore, desirable to provide a financial instrument whose features are modular that can be stored in a manner that reduces the operational complexity of product storage.

### SUMMARY OF THE INVENTION

It is an object of the present invention to obviate or mitigate at least one disadvantage of previous financial service instruments. It is a particular object of the present invention to provide a modular financial service instrument that largely eliminates the need for multiple product offerings.

In a first aspect of the present invention, there is provided a system for providing a modular financial service instrument associated with a customer account. The system comprises a database, a profile generator, and a profile modifier. The database stores a customer account profile uniquely associated with the customer account. The profile generator creates the customer account profile by activating features selected from a set of features associated with the modular financial service instrument. The set of features can include an annual fee, an interest rate value, a grace period, a payment period, a reward program, an insurance plan, an affinity program, a concierge service, and a design for a card associated with the modular financial service instrument, and may be stored in an offer management table. The profile modifier permits dynamic modification of the customer account profile by updating the selected features. In one embodiment of the present invention, the modular financial service instrument is a credit card, while in alternate embodiments, the modular financial service instrument is selected from a deposit account, a mortgage and a line of credit. In another embodiment, the profile generator includes either a generic application processing system, or a credit card application processing system.

The profile generator of the present invention can include a self-serve interface, a financial institution desktop interface, or a paper application form. The application form can be a tri-fold form integrated with a brochure, one portion of which forms a tracker panel extending beyond an edge of the brochure when the tri-fold form is in a folded out position. The profile generator is operatively connected to an authorisation engine and includes means to deny a profile generation request based on a response received from the authorisation engine. The profile modifier includes a least one of a financial institution desktop interface and a self-serve interface, where the self-serve interface further can include either a customer accessible interactive voice response system or an Internet accessible website interface. The profile modifier includes means for adding and subtracting selected features from the set of selected features associated with the customer account profile, and for changing the subscribed service tier for a selected feature associated with the customer account profile.

In a further embodiment, the present invention further includes a postal management subsystem connected to the database. The postal management subsystem permits modular fulfilment by transmitting informational products to a customer in accordance with the selected features associated with the customer account profile. In another embodiment, the postal management subsystem transmits informational products to the customer when the customer account profile is modified by the profile modifier. The transmitted informational products include only the products associated with the modified features. The system of the present invention may additionally include a statement generator connected to the database, for generating a billing statement associated with the customer account, the billing statement including an itemised fee breakdown for the selected features.

In a second aspect of the present invention, there is provided a modular financial service instrument. The modular financial service instrument comprises a customer account, and a customer account profile uniquely associated with the customer account. The customer account profile includes features selected from a set of features associated with the financial service instrument. This selection of features is dynamically modifiable after creation of the profile. In one embodiment, the customer account is a credit card account, while in an alternate embodiment the customer account is selected from a deposit account, a line of credit and a mortgage. The set of features includes at least one of an annual fee, an interest rate value, a grace period, a payment period, a reward program, an insurance plan, an affinity program, a concierge service and a design for a card associated with the modular financial service instrument, and the selected features determine an annual fee for the modular financial service instrument.

According to a third aspect of the present invention, there is provided a method of providing a modular financial service instrument. The method includes the steps of uniquely associating a customer account profile with a customer account, the customer account profile including features selected from a set of features associated with the modular financial service instrument, and modifying the customer account profile by dynamically changing the selected features. In an embodiment of the method of the present invention, the step of uniquely associating the customer account profile with the customer account includes having a customer select features to associate with the customer account from a set of predefined features. The set of features includes at least one of an annual fee, an interest rate value, a grace period, a payment period, a reward program, an insurance plan, an affinity program, a concierge service and a design for a card associated with the modular financial service instrument. The step of modifying the customer account profile can include receiving a customer request to add or subtract a feature to the set of selected features, and adding or subtracting the requested feature to the set of selected features associated with the customer account profile. In another embodiment, the step of modifying the customer account profile includes changing a subscribed service tier associated with a selected feature.

Other aspects and features of the present invention will become apparent to those ordinarily skilled in the art upon review of the following description of specific embodiments of the invention in conjunction with the accompanying figures.

BRIEF DESCRIPTION OF THE DRAWINGS

Embodiments of the present invention will now be described, by way of example only, with reference to the attached Figures, wherein:

FIG. 1 is an illustration of the prior art storage and profiling of conventional financial service instruments;

FIG. 2 is an illustration of the prior art storage of customer profiles;

FIG. 3 is a prior art method of modifying an option or feature associated with a modular financial service instrument;

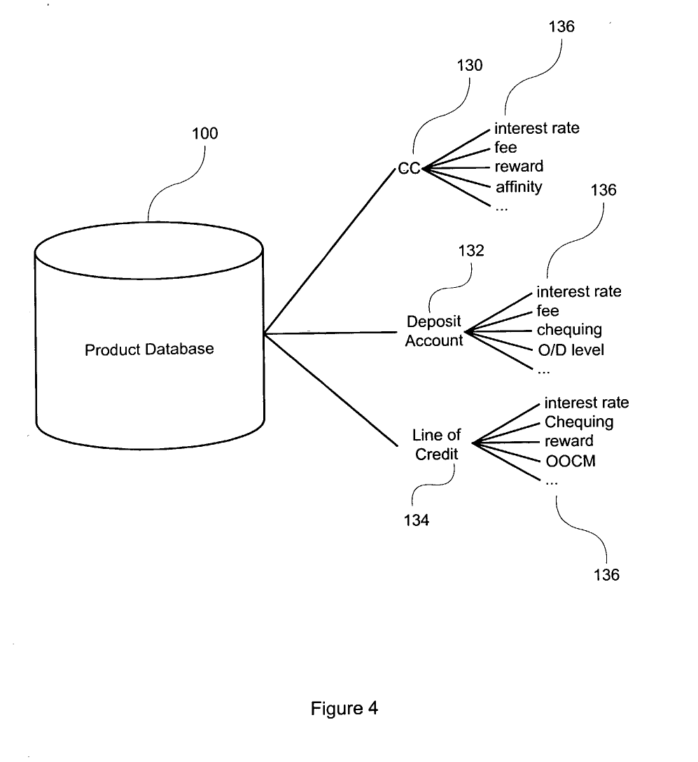

FIG. 4 is an illustration of the storage and profiling of modular financial service instrument according to an embodiment of the present invention;

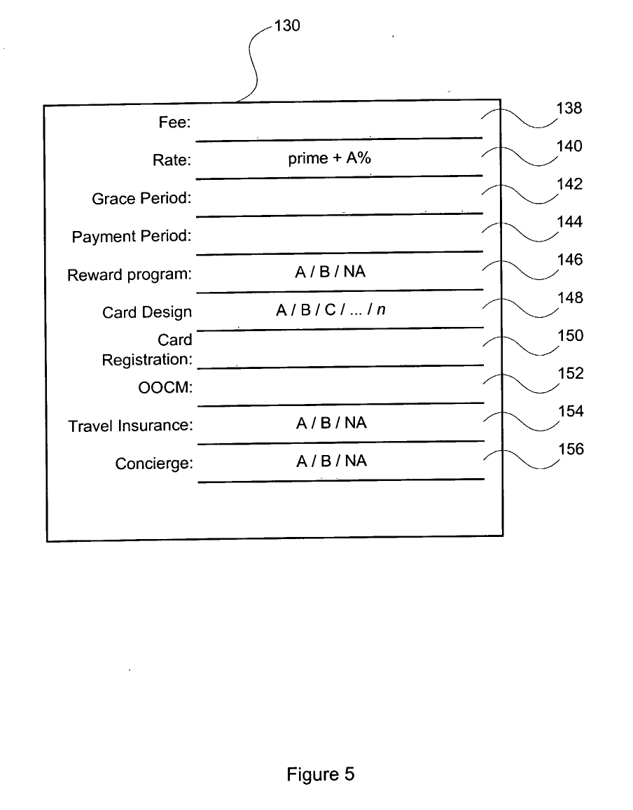

FIG. 5 illustrates the optional features in the profile of a modular financial service instrument of the present invention;

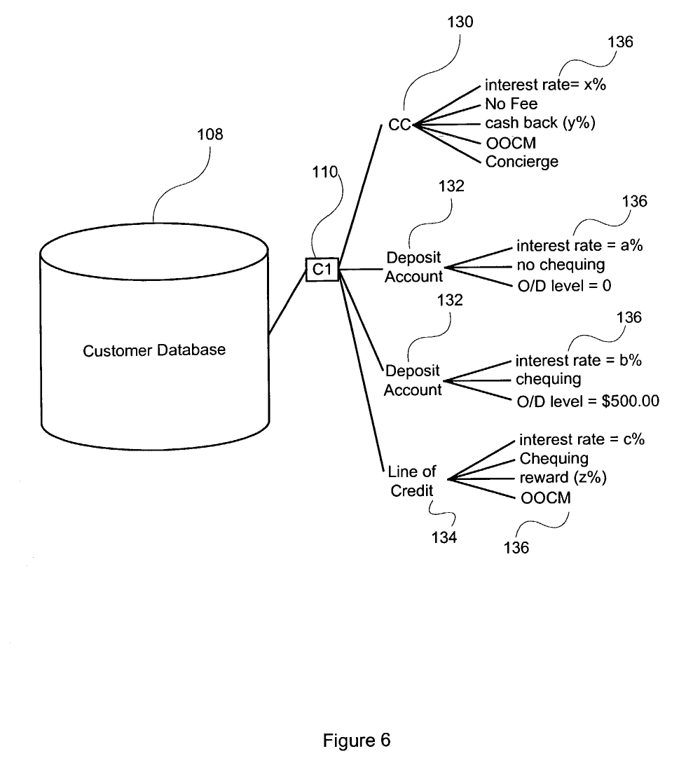

FIG. 6 is an illustration of the storage of customer profiles containing account profiles for modular financial service instruments;

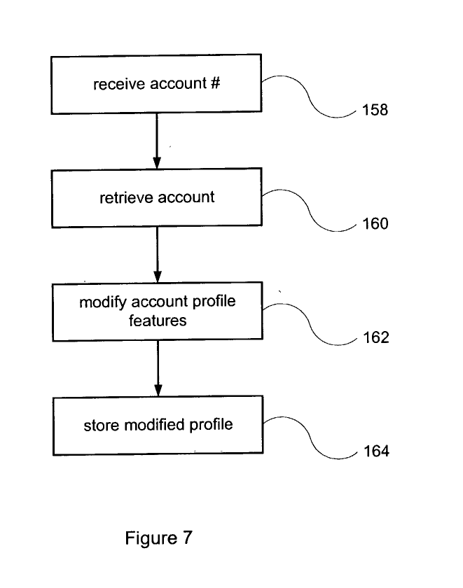

FIG. 7 illustrates a method of modifying a modular financial service instrument;

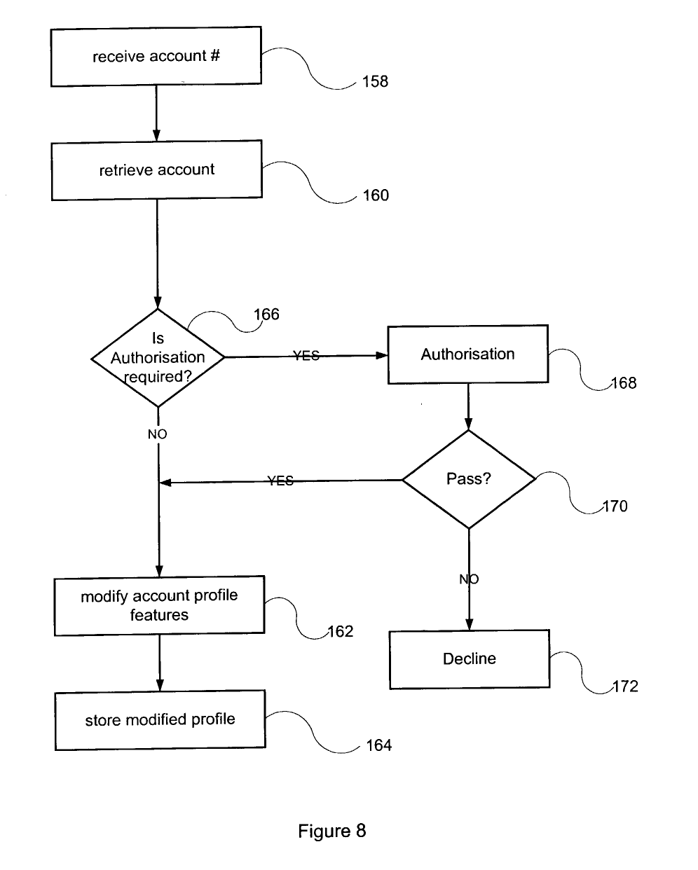

FIG. 8 illustrates an alternate method of modifying a modular financial service instrument;

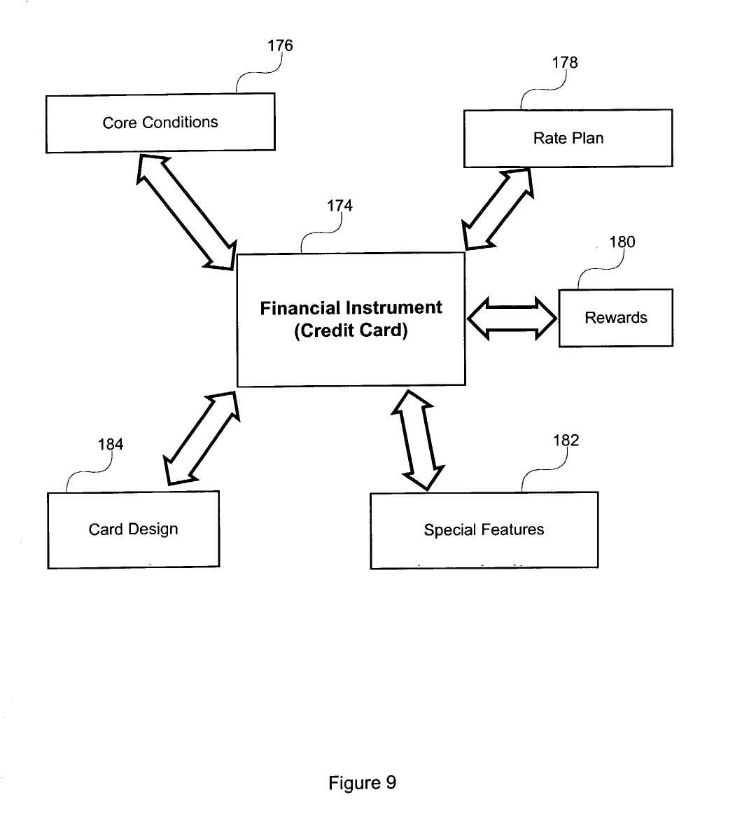

FIG. 9 illustrates a modular credit card having a variety of optional features;

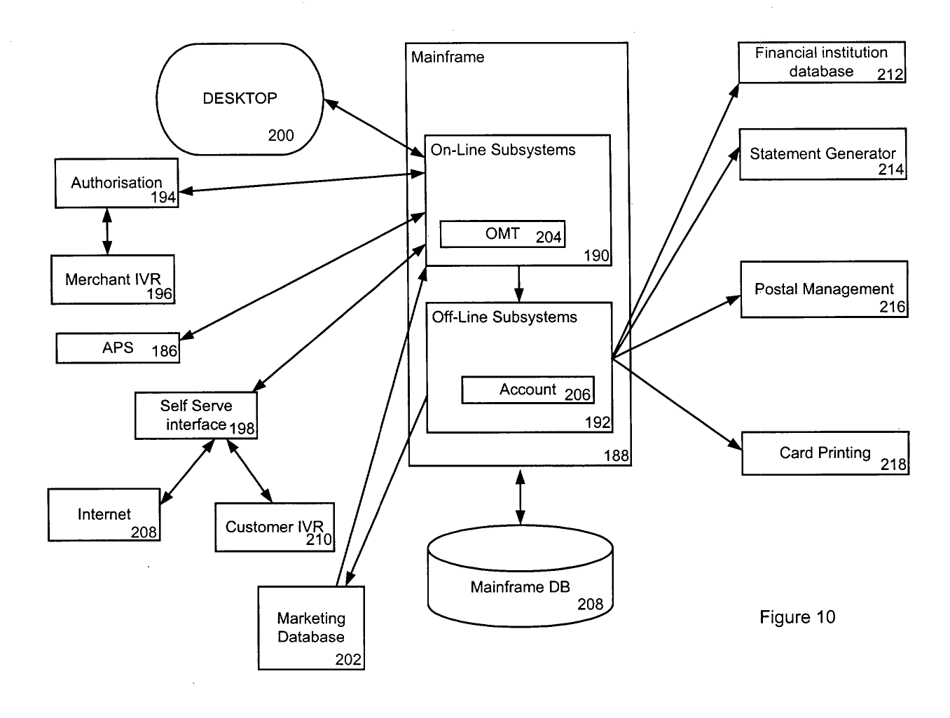

FIG. 10 illustrates a system for implementing a modular credit card; and

FIGS. 11-14 show views of a paper-based feature selector according to the present invention.

### DETAILED DESCRIPTION

Generally, the present invention provides a modular financial service instrument which provides a greater variety of features to a customer while providing for a rationalised operational structure in the handling and processing of the modular financial instrument. The modular financial service instrument can be a credit or charge card, a deposit account, a line of credit, a mortgage, or another financial service instrument that has a variety of options or features. The modular financial service instrument is organised as a base product, to which a series of features can be added. Features can be combined with each other so that an affinity program can be selected simultaneously with a rewards program. Each feature can have a variety of levels, so that rewards can be earned at differing rates, or so that insurance or services can be offered in a tiered fashion. It is possible with the modular financial service instrument of the present invention to also link a cost to each of the options or features.

FIG. 4 illustrates a rationalised operational structure according to an embodiment of the present invention. The product database 100 stores modular profiles 130-134 of financial service instruments. Each of the profiles has a plurality of feature options 136 that define the exact behaviour of the financial instrument. FIG. 5 illustrates in greater detail, the fields used to represent the features in the modular product profile 130. The features can define levels of service, or indicate that a feature is not to be applied to the product. One of skill in the art will readily appreciated that there can be a relationship between the fields, so that, for example, different reward programs exclude each other, and differing levels of feature support are only available if a fee is applied. Modular product profile 130, as illustrated in FIG. 5, includes fields for the annual fee charged 138, the interest rate on outstanding balances 140, the number of days grace between purchase and payment 142, and the length of the payment period 144. Additionally the level of rewards for reward programs 146 can be tiered. As illustrated in FIG. 5, one of two levels, A or B, can be selected, as can a not applicable (NA) option. Additional features that can be selected include card design 148, credit card registration 150, OOCM 152, travel insurance 154 and concierge services 156, which may or may not be available on a tiered basis. A set of rules can be implemented to determine the annual fee on the card 138 on the basis of the other features selected. Additionally, rules can be implemented to prevent enrolment in more than one reward package.

The customer database is illustrated in FIG. 6. Customer database 109 still contains records for each customer 110. Each customer has at least one instance of one modular financial instrument 130, 132, and 134, each of which has a unique account number. This structure can be viewed as each account being an instance of an object, which in this case is a financial instrument. The instancing of a defined object allows each customer 110 to have more than one of a given product, each differentiated by its unique account number.

In another, non-illustrated, embodiment, the various types of financial instruments can each be an instance of a single object, with at least one property used to distinguish between the various financial instruments. This allows a single data structure to represent a credit card, a charge card, a mortgage, a line of credit and a deposit account. One of skill in the art will understand the modifications to the storage and handling requirements associated with this embodiment.

To create a modular financial service instrument, a customer applies for an account, and selects features from a set of features associated with the financial service instrument. The provided selection of features, and customer identifying information, are used to begin the process of creating a modular financial service instrument. This information can be obtained through a banking representative, a mail-in form, or an Internet accessible website. The customer information is used for authorisation, such as a credit check, if required for the creation of a credit card or other debt related instrument. If authorisation is received, a customer account profile is created, and an account number, access number, and customer information are associated with the customer account profile, so that the customer's identifying information is accessible on the basis of the account number. The initial account profile is determined by the features selected by the customer. This allows customers to create a credit card, or other financial service instrument, that suites their individual needs. The selected features and, where applicable, the tiers of service within each feature, each have a cost associated with them. Some of the features may have a cost of $0, while others have an associated annual fee. The sum of the costs associated with each selected feature and tier determines the annual cost of the modular financial service instrument. If the profile of the modular financial instrument is modified, the associated cost of the instrument may change. The change in cost may be implemented on a pro-rated basis where applicable.

FIG. 7 illustrates a methodology for modifying the profile of an existing modular financial instrument according to a method of the present invention. In steps 158 and 160, the account number is retrieved through the access number and used to retrieve the account information as in FIG. 3, except that the account information retrieved includes a modifiable account profile, which describes the financial instrument. In step 162, at least one modifiable feature, such as the reward program level, is modified. The modified profile is stored in 164 for future use. This allows a change in the features of the financial instrument without closing the original account and re-issuing a financial instrument to the customer. This is in contrast to the prior art where such a change would have required the issuance of a new instrument, potentially with a new account number, if the features of a product were sufficiently modified.

A more detailed method of modifying the profile of a modular financial instrument according to an embodiment of the present invention is illustrated in FIG. 8. As in the method of FIG. 7, the account number is received and used to retrieve the modular financial instrument profile in steps 158 and 160. In step 166 a decision is made regarding the nature of the proposed feature modification. Certain feature modifications, such as adding certain insurance packages, such as OOCM, require authorisation based on the age of the customer. Other features may have different requirements that require authorisations, such as credit checks. The determination of whether or not an authorisation is required is made in step 166. If no authorisation is required in 166, steps 162 and 164 are performed as in FIG. 7. If an authorisation is required in 166, the process forks. An authorisation is performed in step 168. If the authorisation is credit related, the check is often performed by an outside agency, which returns a quantifiable credit score and detailed credit history. The result of the authorisation is evaluated in 170 to determine if the customer meets the required authorisation criteria. If the customer fails the authorisation, the feature modification is declined in 172, otherwise steps 162 and 164 progress as before. The nature of the authorisation performed is dependent upon the feature being modified.

The modification of the profile associated with the modular financial service instrument can be initiated by a customer who desires a new set of features, or who wishes to change the tier of service related to a particular feature. A system for allowing the modification of a profile associated with a modular financial service instrument is described below. It will be understood by one of skill in the art that the modification of the profile associated with a modular financial service instrument can be initiated by the financial institution. These financial institution initiated modifications can be initiated for example, as a result of business rules that determine that a customer is no longer eligible for a selected service as a result of past behaviour. Alternatively, the financial institution may modify the account profile to upgrade one of more features, including the credit limit, without consulting the customer, to reflect a change in the status of the customer, or as a reward. None of these changes require the re-issuing of a card associated with the instrument, as a new product has not been issued.

The modular nature of the financial service instruments of the present invention provides a number of benefits that will be explained in relation to credit cards, but are largely applicable to other financial instruments as well. The decoupling of credit limits and feature selection allows customers to design a card that suits their exact needs instead of the needs of a generic customer profile to which they belong by virtue of their credit limit or desired product features. FIG. 9 illustrates the concept of a credit card whose features are modular. The basic credit card 174 has a series of features that can be selected by the customer. The basic credit card 174 has a predefined set of core features 176, which may include an alterable credit limit, a grace period between purchase and payment, a premium charged for foreign exchange services, the minimum payment per billing period, and other standard elements which will be understood by one of skill in the art. All credit cards have values provided for these core features, though the values assigned to the features may be variable. Additionally, associated with credit card 174 is a rate plan 178. The rate plan can include an interest rate that is dependant upon an annual fee, or subject to promotional programs. These promotional programs can include so-called “teaser” rates that are designed to appeal to transfer customers by providing a low initial interest rate. Rewards 180 can also be associated with credit card 174. Rewards 180 can be one of a variety of services, offering frequent flier points, loyalty program points, rebates based on spending patterns, or grocery vouchers. Each rewards program available through rewards 180 can be tiered so that preferred customers, or customers willing to pay an additional fee, can earn rewards at a faster rate than normal. This tiering allows for select groups of customers to be rewarded for a particular behaviour, or can be used as an enticement program, so that during an initial time period a higher rate of reward accumulation is possible.

Special features 182 are also applicable to credit card 174. These special features can include varying levels of travel insurance, for both trip insurance and medical insurance. Additionally, credit card registry, OOCM, and MOBI can be offered as special features, as can a concierge service. Special features 182 can be added or removed at any time from the profile of a particular instance of credit card 174, subject to rules and conditions that are designed to ensure that customers do not abuse the services. Finally, the design 184 of the card itself can become a modular feature. Whereas prior credit card implementations have offered different cards for different levels of service, such as gold or platinum cards, the distinction between cards on the basis of service and credit limit can be eliminated. This allows the customer to select a variety of card designs to suite personal and aesthetic preferences.

As illustrated in FIG. 8, most changes made to the features of credit card 174 no longer require authorisation, nor do they require migration to a new product. For example, conventional systems require a customer to upgrade from a gold card product to a platinum card product in order to receive concierge service. Such an upgrade is likely to require an authorisation step, such as a credit check. The modular financial service instrument of the present invention requires neither further authorisation nor product migration to provide concierge service to the customer. The concierge service can merely be associated to the customer's account profile, and an appropriate fee charged. Because changing a modular card also does not involve issuing a new card, it is no longer necessary for a customer to directly interact with a representative of the issuing financial institution to obtain a new card when it is only new features that are desired. Instead, an automated system can be employed, using such systems as interactive voice response (IVR) and Internet websites, to allow the customer to modify the features of the card. This allows the customer to control the features and options to suite changing needs.

Additionally, the modular nature of credit card 174 allows the financial institution to modify features on a customer by customer basis. These modifications can include the addition of extra grace days for groups of customers who pay their balances in full, but may require a few days more in each payment period, or it may include a change in the interest rate associated with the card to modify a customer's behaviour. A rate change can be made to penalise customers who often miss payments, or a rate change can be made to reward customers who consistently pay at least the minimum payment on time. These variations in core features are feasible because a new product does not need to be created to offer these services. As noted earlier, teaser programs can also be created that offer not just lower interest rates, which tend only to attract customers with large outstanding balances, but teasers can also be created to offer higher rewards for an initial time period, to attract customers who spend large amounts of money on the credit card.

A system to implement transactions on credit card 174 is illustrated in FIG. 10. The system is largely a standard credit card processing system, as will be apparent to one of skill in the art. One of the advantages of modular financial instruments according to the present invention is that they do not require a systemic change in the manner in which transactions are processed. Instead, they appear to most systems as identical to existing instruments. When customers apply for credit cards, their applications are processed by the application processing system (APS) 186. APS 186 creates a customised customer credit card based on the features and options selected by the client from a feature set offered by the offer management table (OMT) 204, which will be discussed in detail below. Upon approval of the application, which may be subject to credit authorisation, APS 186 communicates to the mainframe 188, which has both on-line 190 and off-line 192 subsystems. On-line subsystem 190 connects to APS 186, authorisation engine 194, a self-serve interface 198, financial institution desktop 200 and also has a connection to the marketing database 202. Authorisation engine 194 is used to approve or reject transactions received from merchant IVR 196. Typically, upon attempting a transaction with card 174, a merchant will swipe the card, key in the card number, or call for approval, using the interface of merchant IVR 196. The transaction is submitted to the authorisation engine 194 for approval, to determine if the transaction is within the credit limit of the card, and potentially to verify that the transaction is within a set of approved criteria for the card. Both authorisation engine 194 and merchant IVR 196 are unchanged from those commonly implemented in the financial services industry.

APS 186 processes applications and allows customers to select from features stored in the OMT 204 of the on-line subsystems 190. Whereas in the prior art OMT 204 would contain a plurality of products to which the customer could subscribe in the present embodiment, OMT 204 contains all the features that can be set for card 174. OMT 204 also contains the rules that do not allow multiple reward enrolments and other such restrictions.

When initially used by a customer to set up an account, the self-serve interface 198, in conjunction with APS 186, is an instance of a profile generator according to the present invention. Equally, when a customer's feature selections are first inputted through the desktop 200, it also acts as part of a profile generator. The customer can communicate the feature selections in a number of ways, such as directly to a financial institution employee, in writing on an application form, or through the self-serve interface 198.

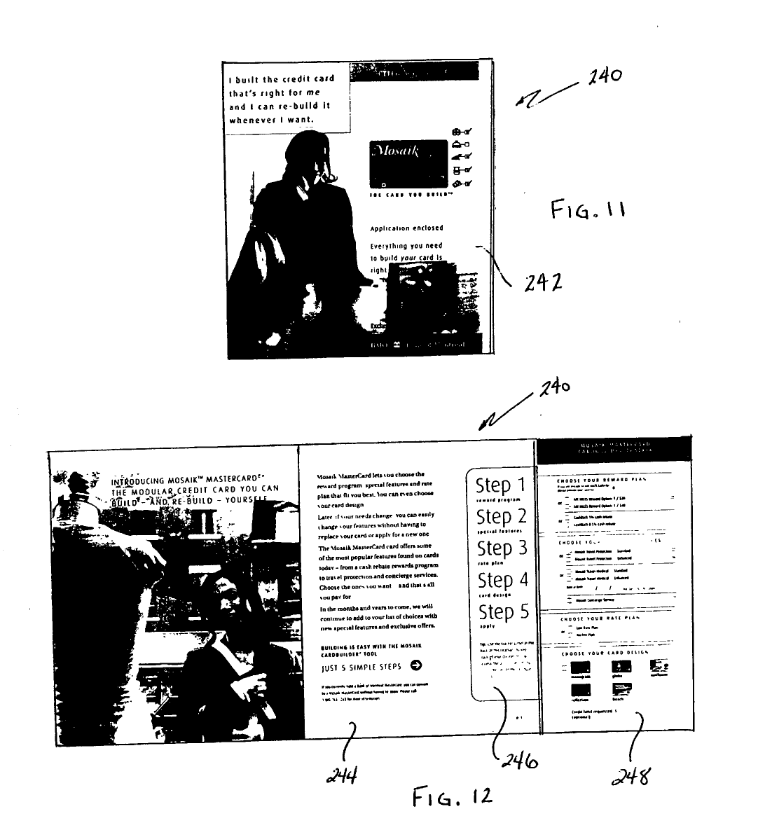

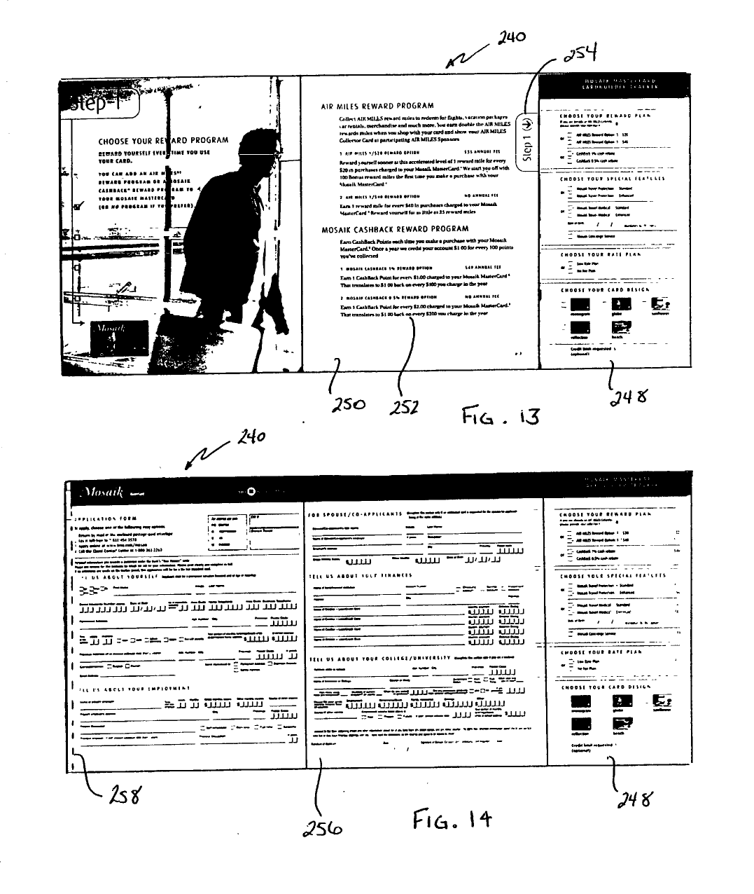

One example of feature selection according to the present invention is shown in FIGS. 11-14, which illustrates a fold-out application brochure 240 for use in profile generation. In FIG. 11 the brochure 240 is shown in its closed position. The front cover 242 and rear cover (not shown) can be used to display appropriate identifying indicia, marketing material, and decorative features. In FIG. 12, the brochure 240 is opened to its first page 244 where the customer begins a five step process 246 to create an account, and to generate a customer account profile. A tracker panel 248 folds out from the rear section of the brochure 240 to permit the customer to record the desired feature selections as the selection process proceeds. Turning to the next page 250 as shown in FIG. 13, the customer begins the first step in the process, and is presented with a detailed explanation 252 of the available rewards programs and their attendant costs. An indicator box 254 directs the customer to make appropriate selections concerning the desired rewards programs on the tracker panel 248. The customer then proceeds to subsequent pages in the brochure (not shown) to select, in turn, special features, a rate plan, and a card design, marking each selection on the tracker panel 248 (steps 2-4). After completing the fourth step, the customer is presented with an application form 256 in a tri-fold format, as shown in FIG. 14, with the tracker panel 248 attached at the far right. The customer completes the form 256, detaches it at a perforation line 258, and delivers or mails it to the offering financial institution. An envelope can also be integrated with the brochure, as will be understood by those of skill in the art.

The desktop 200 and the self-serve interface 198 are also instances of a generic profile modifier. The profile modifiers are designed to allow the customer or the financial institution to modify the credit card profile by updating the selected features. The updating of selected features can include both the addition and subtraction of features, or the changing of the subscribed service tier. The final connection to the on-line subsystem is a marketing database 202, which receives information from the off-line subsystem 192. The features of the marketing database 202 will be discussed in greater detail below. The features selected for card 174 can be modified by the customer, or the institution, through both the self-serve interface 198 and the desktop 200. The desktop 200 is an interface that is used by employees of the financial institution to modify the features of card 174. Desktop 200 can provide an employee in the issuing financial institution the ability to modify the features associated with an account at a customer's request. In enacting a change in the profile of card 174, desktop 200 interacts with the on-line subsystem 190, which transfers the change instruction to the off-line subsystem 192, which then modifies the stored account profile 206.

The separation of on-line and off-line subsystems 190 and 192 is somewhat arbitrary, and is usually done to provide security to the stored account information 206. Both subsystems of mainframe 188 store data in, and retrieve data from, mainframe database 208, which stores OMT 204 and account profile 206 along with other relevant data. If the customer does not want to interact with an individual at the financial institution, the self serve interface 198 can be used. The self service interface 198 provides a connection to the on-line subsystem 190 to, for example, an internet site 208 and a customer IVR 210. This allows the customer to modify features attached to card 174.

Most modifications to the profile of a financial service instrument do not require further authorisation, and can be implemented after a minor delay for processing the requested modification. In many cases, the delay will be until the start of the next business day. Those changes requested by a customer, which require further authorisation, can be flagged appropriately, and held pending approval. Upon approval, the customer can be notified that the modifications have been implemented. Modifications that do not require authorisation are forwarded by the self-serve interface 198 to the account profile 206, though in some embodiments, they will be processed by external systems prior to being recorded in account profile 206. The other modifications made to the account profile 206 are recorded after authorisation has been received.

The off-line subsystem 192 connects to the financial institution database 212, the statement generator 214, postal management subsystem 216, and card printing subsystem 218. The financial institution database 212 contains customer profile 110, and other information about the customer. Database 212 generally correlates the card information with the customer profile 110. The statement generator 214 is used to create a billing statement at fixed intervals. The statement generator 214 also bills the customer for the selected features, such as OOCM, and other special features 182 or rewards, in an itemised fashion. The generated statements are handled by postal management subsystem 216, for mailing to customers. The services and methods used in postal management subsystem 216 are known in the art, and may be provided by outside contracting service providers.

As illustrated in FIG. 9, card design 184 is a user selectable feature, that is provided to card printing subsystem 218, so that a card of the selected design can be printed. Additionally, whereas in the prior art, the card printing service would reprint a card when an account was migrated to a new product, card printing 218 does not reprint the card for re-issue when a new package of features is selected, unless a new card design 184 is chosen.

Postal management 216 and card printing 218 subsystems are integral to modular fulfilment according to the present invention. The transmission of the information products associated with only selected and modified features associated with each customer account profile is referred to herein as modular fulfilment. When a customer subscribes to a new card, a set of information products is sent to the customer detailing the selected features. Whereas the prior art used a different product information package for each product, a modular credit card cannot use a predefined product information package. If a customer has not subscribed to OOCM, then the specific details of OOCM do not need to be provided, but instead a notice alerting the customer that OOCM is available for a set fee, might be desirable. Similarly, when a customer subscribes to a new feature, the details of that feature should be provided to the customer, but the details of the other features need not be resent. The management of these mail-outs can be implemented using a database to track the addition and removal of features, and the dates on which the last mail-out occurred for each feature. A set of business rules can be designed to provide customers with relevant mail-outs whenever features are added, or whenever features are changed sufficiently. These mail-outs can be provided to the customer with the next monthly billing statement, or can be sent to the customer as soon as the change is made, depending on the established business rules.

The offline subsystem 192 also connects, as noted above, to marketing database 202. Marketing database 202 can provide a greater amount of detail than conventional card and spending tracking systems do. Because marketing database 202 can examine the features selected by the customer, it is possible to provide a greater granularity of detail in preparing marketing campaigns. Special features, such as OOCM, have typically only been provided with premium cards. However, it may become apparent that a particular feature is unexpectedly popular with a certain group, and a targeted campaign can be directed to other customers in that group. Additionally, as new features are introduced it is possible to use marketing database 202 to determine which customers have subscribed to particular features to derive an initial target demographic. Prior implementations of card and spending tracking systems have not had the ability to validly track customers on the basis of individual features, as it was not possible to determine if a customer had willingly chosen a particular feature, or if the customer has chosen another feature that came bundled with a variety of other features. In combination with the fulfilment services through postal management 216, promotional material can be targeted to a customer based on age, gender, credit levels, selected features and spending habits. This level of granularity of information is unavailable without a modular financial service instrument.

The extension of the modular nature of credit card 174 to other financial instruments will be well understood by those skilled in the art. The back-end processing of [symbol] itep3421Y instruments. One of skill in the art will recognise that it is not necessary that all financial service instruments be recreated as modular instruments, and it is not necessary to change the entire storage structure of an institution so that only modular instruments are stored. It is conceivable that many institutions will implement only one modular instrument, while others will slowly migrate all their instruments to a modular implementation.

Though the above description references credit cards, the modular nature of the present invention allows both credit and charge cards to be created as identical products, with a simple flag that indicates that a balance can be carried between billing periods, and that a defined, rather than dynamically created, spending limit exists.

In the above discussion of modular credit card 174, it was indicated that certain features may be subject to authorisation. In many instances, authorisation is related to a credit check to determine if a customer is eligible for certain new or upgraded features, or is eligible for a new credit limit. In other instances, some features may only be available in designated jurisdictions, or to designated age groups. In these cases authorisation will include a check of the customer location or age as applicable. In the case of certain financial instruments such as mortgages, authorisation may be related to proof of ownership or completion of sale along with other requirements. One of skill in the art will recognise that different financial service instruments will have different authorisation requirements, and that these requirements will affect which features can be associated with the account profile.

Credit card 174 decouples features from credit limits, by allowing customers at all credit levels to select features that are otherwise reserved for premium cards. This allows individuals with low credit limits, but who rent cars often, to select a travel insurance package that includes CDW coverage that would otherwise be unavailable to them. Additionally it allows higher end customers, who already have CDW coverage through their auto insurance, to no longer pay for bundled services that are not wanted.

As new features are created, a field can be added to the profile of each instance of credit card 174. This makes the feature available upon request from the customer, and does not require changing the service plans associated with a bundled card. This allows a financial institution to add optional features that have a narrower interest than services currently offered, in order to attract niche markets. Additionally, because the design of the card is decoupled from the features of the card, it is no longer necessary for the financial institution to re-issue cards whenever a new feature is added.

It should be noted that for business reasons it may be desirable to implement the modular financial service instrument in a hybrid system, that contains both modular and product profile based instruments. In one such system, credit cards may be implemented as modular financial service instruments, while deposit accounts are implemented as a series of distinct products. In another such system, credit cards may be modular, but different product profiles may be established for each affinity program, so that remuneration due to the affinity organisation can be more easily calculated.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A system for providing a modular financial service instrument associated with a customer account, comprising:
a database for storing a customer account profile uniquely associated with the customer account;
a profile generator for creating the customer account profile by activating features selected from a set of features associated with the modular financial service instrument; and
a profile modifier for dynamically modifying the customer account profile by updating the selected features.

2. The system of claim 1, wherein the modular financial service instrument is a credit card.

3. The system of claim 1, wherein the modular financial service instrument is selected from a deposit account, a mortgage and a line of credit.

4. The system of claim 1, wherein the profile generator includes an application processing system.

5. The system of claim 2, wherein the profile generator includes a credit card application processing system.

6. The system of claim 5, wherein the profile generator includes an application form.

7. The system of claim 6, wherein the application form is a tri-fold form integrated with a brochure, one portion of the tri-fold form being a tracker panel extending beyond an edge of the brochure when the tri-fold form is in a folded out position.

8. The system of claim 1, wherein the set of features includes at least one of an annual fee, an interest rate value, a grace period, a payment period, a reward program, an insurance plan, an affinity program, a concierge service, and a design for a card associated with the modular financial service instrument.

9. The system of claim 2, wherein the set of features associated with the credit card are stored in an offer management table.

10. The system of claim 1, wherein the profile generator is operatively connected to an authorisation engine.

11. The system of claim 10, wherein the profile generator further includes means to deny a profile generation request based on a response received from the authorisation engine.

12. The system of claim 1, wherein at least one of the profile generator and the profile modifier includes a least one of a financial institution desktop interface and a self-serve interface.

13. The system of claim 12, wherein the self-serve interface further includes a customer accessible interactive voice response system.

14. The system of claim 12, wherein the self-serve interface further includes an Internet accessible website interface.

15. The system of claim 1, wherein the profile modifier includes means for adding and subtracting selected features from the set of selected features associated with the customer account profile.

16. The system of claim 1, wherein the profile modifier includes means for changing the subscribed service tier for a selected feature associated with the customer account profile.

17. The system of claim 1, further including:
a postal management subsystem, operatively connected to the database, for transmitting informational products to a customer associated with the customer account profile, the informational products containing information associated with at least one of the selected features associated with the customer account profile.

18. The system of claim 17, wherein the postal management subsystem transmits informational products to the customer when the customer account profile is modified by the profile modifier, the transmitted informational products include only the products associated with the features modified.

19. The system of claim 1, further including a statement generator, operatively connected to the database, for generating a billing statement associated with the customer account, the billing statement including an itemised fee breakdown for the selected features.

20. A modular financial service instrument, comprising:
a customer account; and
a customer account profile uniquely associated with the customer account, the customer account profile including features selected from a set of features associated with the financial service instrument, the selection of features being dynamically modifiable after creation of the profile.

21. The modular financial service instrument of claim 20, wherein the customer account is a credit card account.

22. The modular financial service instrument of claim 20, wherein the customer account is selected from a deposit account, a line of credit and a mortgage.

23. The modular financial service instrument of claim 21, wherein the set of features includes at least one of an annual fee, an interest rate value, a grace period, a payment period, a reward program, an insurance plan, an affinity program, a concierge service and a design for a card associated with the modular financial service instrument.

24. The modular financial service instrument of claim 20, wherein the selected features determine an annual fee for the modular financial service instrument.

25. A method for providing a modular financial service instrument, comprising:
uniquely associating a customer account profile with a customer account, the customer account profile including features selected from a set of features associated with the modular financial service instrument; and
modifying the customer account profile by dynamically changing the selected features.

26. The method of claim 25, wherein the step of uniquely associating the customer account profile with the customer account includes having a customer select features, to associate with the customer account, from a set of features including at least one of an annual fee, an interest rate value, a grace period, a payment period, a reward program, an insurance plan, an affinity program, a concierge service and a design for a card associated with the modular financial service instrument.

27. The method of claim 25, wherein the step of modifying the customer account profile includes:
receiving a customer request to add or subtract a feature to the set of selected features; and
adding or subtracting the requested feature to the set of selected features associated with the customer account profile.

28. The method of claim 25, wherein the step of modifying the customer account profile includes changing a subscribed service tier associated with a selected feature.
